(19) United States
(12) Patent Application Publication
(10) Pub. No.: US 2007/0111592 A1
(43) Pub. Date: May 17, 2007

(54) Modular plug strip

(76) Inventor: Leslie Frank Smith, Rockwall, TX (US)

Correspondence Address: Steven Thrasher, 391 Sandhill Dr., Richardson, TX, 75080, US

(21) Appl. No.: 11/274,802

(22) Filed: Nov. 15, 2005

(51) Int. Cl. H01R 11/00

(52) U.S. Cl. 439/502

(57) ABSTRACT

The invention teaches using a directional light source to direct light at a target having directional indicia thereon. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### TECHNICAL FIELD OF THE INVENTION

The invention relates generally to electricity delivery systems, and more particularly to plug strip.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Plug strip (sometimes called “wire mold”, and sometimes improperly identified as one of its components, called a “raceway”) is used primarily in commercial application in major retailers such as Home Depot®, Circuit City®, Lowes® and the like to deliver electricity primarily to lighting and other display devices. In addition, plug strip is used at data centers, manufacturing facilities, and other locations where demand for access to electrical plugs is quite intense. Accordingly, guidance systems have been developed to help users properly position a large item. However, none of the existing wire mold systems provide easy to install and adjust modular systems—in fact, existing systems of wire mold are typically at least tow-piece construction that first require the mounting of a back piece, complex wiring, and then the installation of a front piece. Further complexity is introduced at mechanical joints (typically every four to five feet). This results in a significant amount of expert labor being required for the safe installation of existing systems. Furthermore, the large number of mechanically dependent and fragile items lends itself to an increasingly complex and unreliable electrical delivery system. In the real world, this translates to fire and personal safety hazards. The present invention solves these and other problems.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 shows a modular plug strip system comprising a starter strip and an expansion strip.

FIG. 2 illustrates a modular plug strip system mounted to a display.

FIGS. 3a and 3b illustrate alternative plug receptacle and prong types.

FIGS. 4 and 5 show alternative starter boxes.

FIG. 6 illustrates an end of a plug strip that may be snapped-off, or through which an attachment means is provided.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Of course, the foregoing discussions and definitions are provided for clarification purposes and are not limiting. Words and phrases are to be given their ordinary plain meaning unless indicated otherwise.

Description of the Drawings

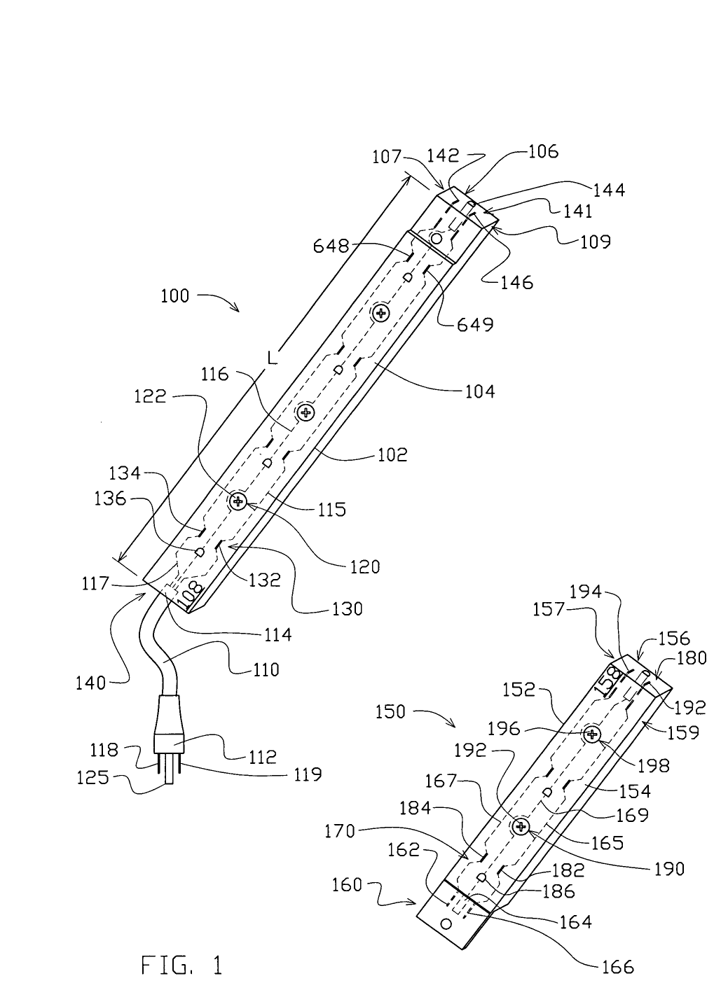

FIG. 1 shows an electrical system comprising a starter strip 100 and an expansion strip 150. The starter strip 100 is preferably a generally box-shaped elongated housing of length L, having an interior 104. The housing 102 also comprises exterior surfaces including a backing 106 that is coupled to a facing 108 via a top 107 and a bottom 109, a first end 140 and a second end 141. The housing 102 may be of single mold construction from a fire-resistant plastic, multi-mold plastic, or metal. Of course, the variety of materials available for construction are widely known to those of skill in the materials, and these equivalent materials are hereby incorporated into the invention. In addition, it is preferred that the housing 102 arrives at the point of installation as a prefabricated unit for quick and simple installation.

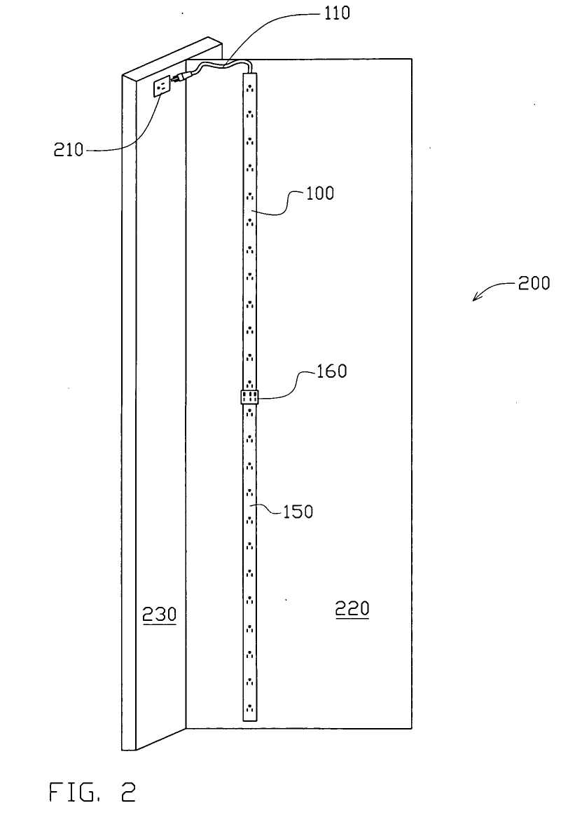

The facing 108 has a first mounting hole 120 through which may pass a screw 122, wire, or rivet, for example, so that the starter strip 100 may be mounted to a surface. The mounting hole 120 preferably comprises a channel of non-conductive material, and may be threaded. In addition to the mounting hole 120 an additional mounting holes receive an additional screws. Referring briefly to FIG. 2, which illustrates a modular plug strip system mounted to a display 200, one may view an exemplary mounting. The display 200 is generally configured as an electric gondola for retail, and includes a backing 220 standing upon a footing 230. The footing 230 includes an electrical outlet 210 to which may attach the electrical source wiring 110. Accordingly, one may see the starter strip 100 coupled to the extension strip 150, each being mounted to the backing 220. In FIG. 2, one will also see a cover plate 160 that covers and electrically isolates the starter strip 100 and the extension strip 150. Of course, equivalents of the first mounting hole 120 are known to those of ordinary skill in the mechanical and electrical arts to mount electrical strip to surfaces, and are hereby incorporated by reference into this disclosure.

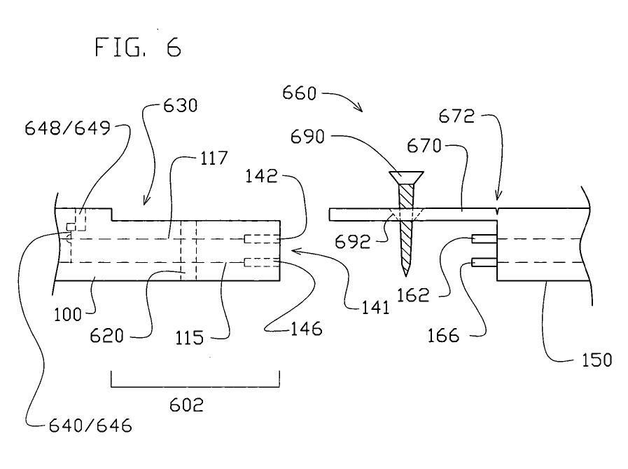

The housing 102 comprises a first electrical source delivery channel 116 in the first end through which passes an electrical source wiring 110 into the interior 104. The electrical source wiring 110 could be any wire-type, and preferably comprises a first wire 115 being coupled between a first electrical source coupling 118 and a first outlet prong receptacle coupling (FIG. 6), the first outlet prong receptacle coupling coupled to a first outlet prong receptacle 132 located in the facing 108. Although gauges for carrying less or more amperage are available, preferably each wire is of a gauge capable of carrying 20 amperages. The electrical source wiring 110 also comprises a second wire 117 coupled between a second electrical source coupling 119 and a second outlet prong receptacle (FIG. 6), the second outlet prong receptacle coupling coupled to a second outlet prong receptacle 134 located in the facing 108. A third wire 116 likewise couples a third electrical source coupling 125 to a third outlet prong receptacle 134. The portions of the wires 115, 117, that couple to the electrical source couplings 118, 119 are herein called electrical source coupling portion of the wires 115, 117, and the portions of the wires 115, 117 that couple to the outlet prong receptacles 132, 134, are herein called outlet prong receptacle couplings. As is seen in FIG. 1, the first and second outlet prong receptacles 132, 134 are co-located in a generally parallel manner on the facing to form a first single electrical outlet, and may also include the third outlet prong receptacle 136 in a three-prong outlet configuration. Of course, it is understood that a great many outlet standards exist, and the present invention may be configured to accommodate any equivalent plug configuration.

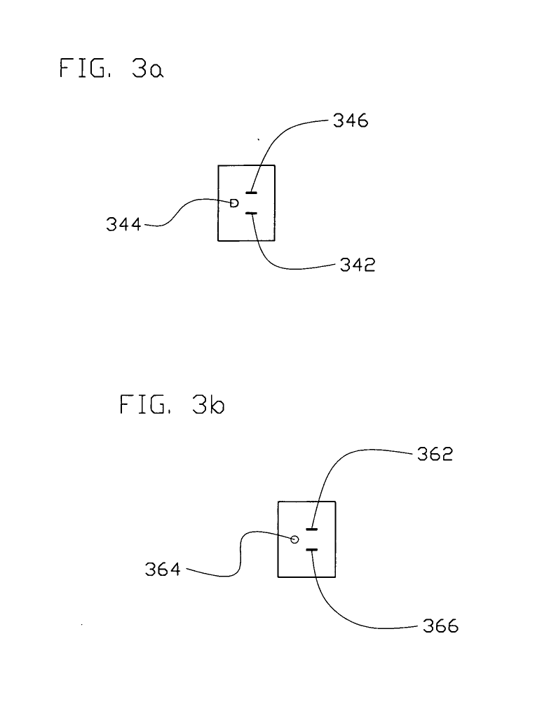

The first wire 115 further couples to a third outlet prong receptacle 146, and the second wire 117 further couples to a fourth outlet prong receptacle 142 in manners known to those of skill in the electrical arts. The third and fourth outlet prong receptacles 142, 146 are co-located in a generally parallel manner on the second end 141 to form a second single electrical outlet as described above, and as known to those of ordinary skill in the electrical arts. The invention thus contemplates an electrical outlet upon some surface other than the facing 108. Accordingly, referring to FIGS. 3a and 3b which illustrate alternative plug receptacle and prong types, one can see that the invention is not limited to a particular type of outlet receptacle configuration. Note also that FIG. 3a is a view of the second end 141 of the starter strip 100 and comprises a first prong 342, a second prong 344, and a third prong 346. Similarly, FIG. 3b is a view of the first end 160 of the extension strip 150, and includes a first prong receptacle 362, a second prong receptacle 364, and a third prong receptacle 366.

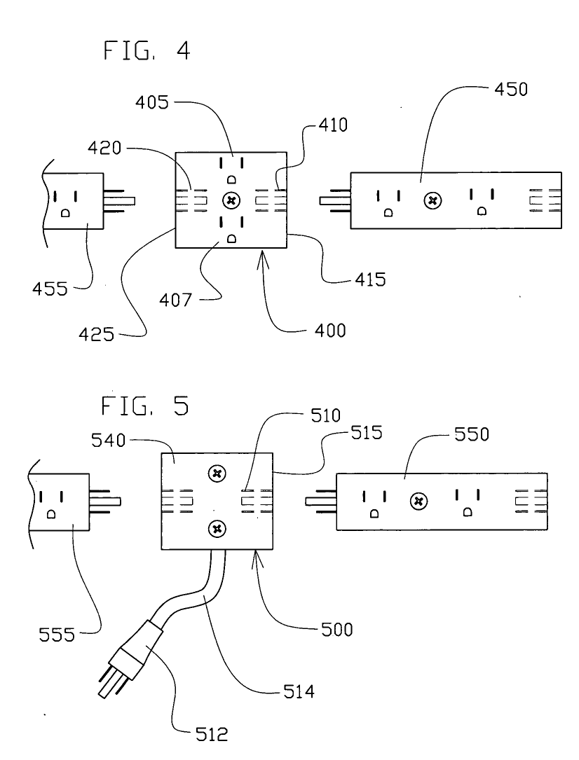

Additional starter strips 100 are illustrated in FIGS. 4 and 5. FIGS. 4 and 5 show alternative starter strips embodied as starter boxes 400, 500. The interior detail of the starter strip 100 is described above, and the interior detail of the expansion strip 150 is defined below. The first starter box 400 preferably has a backing plug that plugs directly into an outlet. The first starter box 400 has a first facing outlet 405, a second facing outlet 407, a first side outlet 410 on a first side 415 and a second side outlet 420 on a second side 225. Each of the sides 415, 425 are preferably approximately perpendicular to the mounting surface, and preferably approximately perpendicular to the facing such that when the extensions strip 450, 455 are connected thereto, the extension strips 450, 455 are either approximately horizontal or approximately vertical. The first starter box 400 preferably has a backing plug that plugs directly into an outlet. The second starter box 500 has a no facing outlets-only a first side outlet 510 on a first side 515 and a second side outlet 520 on a second side 525. Each of the sides 515, 525 are preferably approximately perpendicular to the mounting surface, and preferably approximately perpendicular to the facing 540 such that when the extensions strip 550, 555 are connected thereto, the extension strips 550, 555 are either approximately horizontal or approximately vertical. A plug 512 is used to carry electricity from an outlet to the second starter box 500 via an electrical source wiring 514.

Referring again to FIG. 1, a second apparatus, the extension strip 150 is preferably a generally box-shaped elongated housing 152, having an interior 154. The housing 152 also comprises exterior surfaces including a backing 156 that is coupled to a facing 158 via a top 157 and a bottom 159, a first end 160 and a second end 180. The housing 152 may be, but is not necessarily, of the same material as the starter strip housing 102. It is preferred that the housing 152 arrives at the point of installation as a prefabricated unit for quick and simple installation.

The facing 158 has a first mounting hole 190 through which may pass a screw 192, wire, or rivet, for example, so that the extension strip 150 may be mounted to a surface. In addition to the first mounting hole 190 an additional mounting hole 198 receive an additional screw 196. The mounting hole 190 preferably comprises a channel of non-conductive material, and may be threaded.

The housing 152 comprises a first electrical source delivery area in the first end 160, the first electrical source delivery area comprising a first outlet prong 162 and a second outlet prong 166 being co-located and in a generally parallel configuration, and which together form a first electrical plug. Of course, the first electrical source delivery area may also comprises a third prong 164.

A first wire 165 is coupled between the first prong 162 and a first outlet prong receptacle coupling (such as that shown in FIG. 6), the manner of which is known to those of ordinary skill in the electrical arts. The first outlet prong receptacle coupling is coupled to a first outlet prong receptacle 182 located in the facing 158. Although gauges for carrying less or more amperage are available, preferably each wire is of a gauge capable of carrying 20 amperages. A second wire 167 is coupled between the second prong 166 and a second outlet prong receptacle (FIG. 6), the second outlet prong receptacle coupling coupled to a second outlet prong receptacle 184 located in the facing 158. A third wire 169 likewise couples the third prong 164 to a third outlet prong receptacle 186. The portions of the wires 165, 167, that couple to the prongs 162, 166 are herein called electrical source coupling portion of the wires 165, 167, and the portions of the wires 165, 167 that couple to the outlet prong receptacles 182, 184, are herein called outlet prong receptacle couplings.

As is seen in FIG. 1, the first and second outlet prong receptacles 182, 184 are co-located in a generally parallel manner on the facing to form a first single electrical outlet, and may also include the third outlet prong receptacle 186 in a three-prong outlet configuration. Of course, it is understood that a great many outlet standards exist, and the present invention may be configured to accommodate any equivalent plug configuration.

The first wire 165 further couples to a third outlet prong receptacle 192, and the second wire 167 further couples to a fourth outlet prong receptacle 194 in manners known to those of skill in the electrical arts. The third and fourth outlet prong receptacles 192, 194 are co-located in a generally parallel manner on the second end 180 to form a second single electrical outlet as described above, and as known to those of ordinary skill in the electrical arts. The invention thus contemplates an electrical outlet upon some surface other than the facing 158. In addition, it is desirable that the second end of the starter strip 100 mates with the first end of the extension strip 150 in a manner that prevents the exposure of any conductive surfaces at the end.

FIG. 6 is a close-up of the second end 141 of the starter strip 100 and the first end 160 of the extension strip 150, which shows that an end of a strip may be snapped-off, and that threaded mounting holes 620, 692 are provided for attaching the starter strip 100 and extension strip 150 to a surface. Accordingly, the second end 141 of the starter strip 100 comprises a formed extension 602, the formed extension 602 being configured for coupling to a matched end 660 of an extension strip 150. Here, the-formed extension 602 comprises a generally planar recessed top portion 630, and includes the threaded mounting hole 620. From this view, it is seen that the electrical receptacles 142, 146 are located therein, and that they are coupled via the wires 155, 157 to the electrical receptacle couplings 642, 646 that can carry electricity to the electrical receptacles 648, 649. Of course, many equivalent means may be utilized to achieve similar results, and such means are incorporated within the scope of the claims.

Likewise, the first end 160 of the extension strip 150 comprises a formed extension plate 670. The formed extension plate 670 has a width, height, and length dimensions that conform to the planar recessed top portion 630 of the formed extension 602, and preferably hermetically couples thereto. Electrical prongs 162, 164 are located at first end 160.

The extension 670 comprises a break-away perforation 672 that allows for a user to snap-off or otherwise remove a portion of the extension 670 from the extension strip 150. Accordingly, in the even that a strip (starter or extension) is the “last” strip in a sequence, then the formed extension may be removed and a plug cover can be placed over any exposed prongs 162, 166. Similarly, the end 141 may be plugged with any standard receptacle cover to prevent access to the receptacles 142, 146. In addition, the extension 670 comprises a mounting hole 692 such that when the extension strip 150 is mated with the starter strip 100, the mounting hole 692 aligns with the mounting hole 620 so that a single screw 690 or other securing piece can pass through both the starter strip 100 and the extension strip 150 and secure them both to a surface, and/or each other.

Though the invention has been described with respect to a specific preferred embodiment, many variations and modifications (including equivalents) will become apparent to those skilled in the art upon reading the present application. It is therefore the intention that the appended claims and their. equivalents be interpreted as broadly as possible in view of the prior art to include all such variations and modifications.

I claim:

1. An electrical system, comprising:
a first apparatus, comprising
a generally box-shaped elongated housing having an interior, the housing also comprising exterior surfaces including a backing that is coupled to a facing via a top and a bottom, a first end, and a second end;
the facing having a first mounting means extending therethrough;
the housing having a first electrical source delivery channel in the first end through which passes an electrical source wiring into the interior;
the electrical source wiring comprising a first wire having a first electrical source coupling and a first outlet prong receptacle coupling;
the first outlet prong receptacle coupling coupled to a first outlet prong receptacle located in the facing;
the electrical source wiring comprising a second wire having a second electrical source coupling and a second outlet prong receptacle coupling;
the second outlet prong receptacle coupling coupled to a second outlet prong receptacle located in the facing;
the first and second outlet prong receptacles being co-located in a generally parallel manner on the facing to form a first single electrical outlet;
the first wire being further coupled to a third outlet prong receptacle;
the second wire being further coupled to a fourth outlet prong receptacle; and
the third and fourth outlet prong receptacles being co-located in a generally parallel manner on the second end to form a second single electrical outlet;
a second apparatus, comprising:
a generally box-shaped elongated housing having an interior, the housing also comprising exterior surfaces including a backing that is coupled to a facing via a top and a bottom, a first end, and a second end;
the facing having a second mounting means extending therethrough;
the housing having a first electrical source delivery area in the first end, the first electrical source delivery area comprising a first outlet prong and a second outlet prong being co-located and in a generally parallel configuration, and which together form a first electrical plug;
a first wire having a first electrical source coupling and a first outlet prong receptacle coupling;
the first wire being coupled between the first outlet prong and a first outlet prong receptacle located in the facing;
a second wire having a second electrical source coupling and a second outlet prong receptacle coupling;
the second wire being coupled between the second outlet prong and a second outlet prong receptacle located in the facing;
the first and second outlet prong receptacles being co-located in a generally parallel manner on the facing to form a first single electrical outlet;
the first wire being further coupled to a third outlet prong receptacle;
the second wire being further coupled to a fourth outlet prong receptacle; and
the third and fourth outlet prong receptacles being co-located in a generally parallel manner on an exterior surface other than the facing to form a second single electrical outlet.

2. The system of claim 1 further comprising a first screw extending through the first mounting means and to a mounting surface, and a second mounting screw extending through the second mounting means to the mounting surface.

3. The system of claim 1 wherein the first end of the second apparatus comprises a formed extension, the formed extension having a circumference less than that of the circumference of the facing, backing, top and bottom, the first electrical plug being generally located within the formed extension.

4. The system of claim 5 wherein the second end of the first apparatus comprises a formed extension, the formed extension has an interior cavity defined by a circumference that accommodates the exterior circumference of the first end of the second apparatus, the second electrical receptacle of the first apparatus being located within the cavity.

5. The system of claim 4 wherein the formed extension comprises a break-channel that allows for a user to remove a portion of the formed extension from the first apparatus.

6. The system of claim 3 wherein the formed extension comprises a mounting.

7. The system of claim 2 wherein the mounting comprises a channel of non-conductive material.

8. The system of claim 1 wherein each wire is of a gauge capable of carrying 20 amperages.

9. The system of claim 4 wherein the formed extension comprises a mounting.

10. The system of claim 1 wherein the second apparatus comprises a box-shape having a bend therewith.

11. An apparatus, comprising:
a generally box-shaped housing having an interior, the housing also comprising exterior surfaces including a backing that is coupled to a facing via a top and a bottom, a first end, and a second end;
the facing having a mounting means extending therethrough;
the housing having a first electrical source delivery channel through a surface through which passes an electrical source into the interior;
electrical source wiring coupled to the electrical source;
the electrical source wiring comprising a first wire having a first electrical source coupling and a first outlet prong receptacle coupling;
the first outlet prong receptacle coupling coupled to a first outlet prong receptacle located in a first exterior surface;
the electrical source wiring comprising a second wire having a second electrical source coupling and a second outlet prong receptacle coupling;
the second outlet prong receptacle coupling coupled to a second outlet prong receptacle located in the first exterior surface;
the first and second outlet prong receptacles being co-located in a generally parallel manner on the first exterior surface to form a first single electrical outlet;
the first wire being further coupled to a third outlet prong receptacle;
the second wire being further coupled to a fourth outlet prong receptacle; and
the third and fourth outlet prong receptacles being co-located in a generally parallel manner on a second exterior surface to form a second single electrical outlet.

12. An apparatus, comprising:
a generally box-shaped elongated housing having an interior, the housing also comprising exterior surfaces including a backing that is coupled to a facing via a top and a bottom, a first end, and a second end;
the facing having a first mounting means extending therethrough and a second mounting means extending therethrough;
the housing having a first electrical source delivery area in the first end, the first electrical source delivery area comprising a first outlet prong and a second outlet prong being co-located and in a generally parallel configuration, and which together form a first electrical plug;
a first wire having a first electrical source coupling and a first outlet prong receptacle coupling;
the first wire being coupled between the first outlet prong and a first outlet prong receptacle located in the facing;
a second wire having a second electrical source coupling and a second outlet prong receptacle coupling;
the second wire being coupled between the second outlet prong and a second outlet prong receptacle located in the facing;
the first and second outlet prong receptacles being co-located in a generally parallel manner on the facing to form a first single electrical outlet;
the first wire being further coupled to a third outlet prong receptacle;
the second wire being further coupled to a fourth outlet prong receptacle; and
the third and fourth outlet prong receptacles being co-located in a generally parallel manner on an exterior surface other than the facing to form a second single electrical outlet.
